(19) United States
(12) Patent Application Publication
(10) Pub. No.: US 2012/0221374 A1
(43) Pub. Date: Aug. 30, 2012

(54) MEASURING INFORMATION COHESION IN AN OPERATING ENVIRONMENT

(75) Inventors: Liana M. Kiff, Morristown, NJ (US); Anand Tharanathan, Morristown, NJ (US)

(73) Assignee: HONEYWELL INTERNATIONAL INC., Morristown, NJ (US)

(21) Appl. No.: 13/034,413

(22) Filed: Feb. 24, 2011

(51) Int. Cl. G06Q 10/00

(52) U.S. Cl. 705/7.28

(57) ABSTRACT

Devices, methods, and systems for measuring information cohesion in an operating environment are described herein. One or more device embodiments include a memory and a processor coupled to the memory. The processor can be configured to execute executable instructions stored in the memory to receive a measurement of an information cohesion factor associated with an operating environment through an interaction with a human user via a user interface for information entry, analysis, and visualization, and determine a risk score associated with the operating environment by applying a weighting factor to the measurement of the information cohesion factor, wherein the weighting factor is based, at least in part, on a cognitive effect associated with the information cohesion factor.

### TECHNICAL FIELD

The present disclosure relates to devices, methods, and systems for measuring information cohesion in an operating environment.

### BACKGROUND

An operator in an operating environment (e.g., a control room, such as, for instance, the control room of a commercial facility, manufacturing plant, or petrochemical processing or refining facility) may access (e.g., collect, use, and/or assimilate) a number of different items and/or types of information (e.g., data) from a number of different and/or separate information sources in order to operate the environment (e.g., the facility or plant) effectively, efficiently, and/or safely. For example, the operator may access information displayed on one or more computer screens in the operating environment, information verbally communicated to the operator from other individuals in the operating environment, and/or information printed in operating procedures and/or equipment manuals.

Accessing the different information from the different and/or separate information sources, however, can be difficult and/or time consuming for the operator, which can have a negative cognitive impact on the operator. For example, having to access different information from different and/or separate information sources can make it difficult and/or time consuming for the operator to make the right decisions with the right information needed to effectively, efficiently, and/or safely operate the environment. For instance, having to access different information from different and/or separate information sources can make it difficult and/or time consuming for the operator to access and/or integrate information from multiple and/or contextually different sources to make an efficient decision.

The decision making process of the operator can become even more critical in safety-critical systems (e.g., manufacturing plants and petrochemical processing and refining facilities) that are highly dynamic and/or complex in nature. For example, in such systems a few minutes in the operator's decision making process can be the difference between a minor process upset (e.g., lost revenue) and a major incident (e.g., injury to humans and/or the environment).

### BRIEF DESCRIPTION OF THE DRAWINGS

FIG. 1 illustrates a computing device for measuring information cohesion in an operating environment in accordance with one or more embodiments of the present disclosure.

FIGS. 2A-2C illustrate portions of tabular information defined in accordance with one or more embodiments of the present disclosure.

### DETAILED DESCRIPTION

Devices, methods, and systems for measuring information cohesion in an operating environment are described herein. One or more device embodiments include a memory and a processor coupled to the memory. The processor can be configured to execute executable instructions stored in the memory to receive a measurement of an information cohesion factor associated with an operating environment through an interaction with a human user via a user interface for information entry, analysis, and visualization, and determine a risk score associated with the operating environment by applying a weighting factor to the measurement of the information cohesion factor, wherein the weighting factor is based, at least in part, on a cognitive effect associated with the information cohesion factor.

One or more embodiments of the present disclosure can be used to determine the cognitive impact that accessing (e.g., collecting, using, and/or assimilating) different items and/or types of information from different and/or separate information sources can have on an operator in an operating environment. For example, one or more embodiments of the present disclosure can be used to determine how difficult and/or time consuming accessing different items and/or types of information from different and/or separate information sources can make it for the operator to make the right decisions with the right information needed to effectively, efficiently, and/or safely operate the environment.

Further, a layperson may be able to use one or more embodiments of the present disclosure to determine the cognitive impact that accessing different items and/or types of information from different and/or separate information sources can have on the operator in the operating environment. For example, a person who is familiar with (e.g., has knowledge and/or understanding of) the operating environment, but is not familiar with the underlying psychological components of human cognition and/or competent cognitive engineering methods, may be able to use one or more embodiments of the present disclosure to determine the cognitive impact that accessing different items and/or types of information from different and/or separate information sources can have on the operator in the operating environment.

Additionally, one or more embodiments of the present disclosure can be used to recommend improvements to the operating environment that could reduce the cognitive impact that accessing the information can have on the operator. For example, one or more embodiments of the present disclosure can be used to reduce the difficulty and/or time needed for the operator to access the information needed by the operator to make the right decisions to effectively, efficiently, and/or safely operate the environment.

In the following detailed description, reference is made to the accompanying drawings that form a part hereof. The drawings show by way of illustration how one or more embodiments of the disclosure may be practiced. These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

As used herein, “a” or “a number of” something can refer to one or more such things. For example, “a number information cohesion factors” can refer to one or more information cohesion factors.

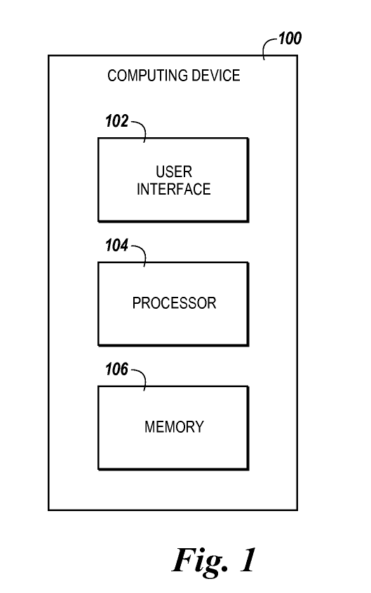

FIG. 1 illustrates a computing device 100 for measuring information cohesion in an operating environment in accordance with one or more embodiments of the present disclosure. Computing device 100 can be, for example, a desktop computing device, a laptop computing device, or a portable handheld computing device, such as, for instance, a portable handheld mobile phone, media player, or scanner. However, embodiments of the present disclosure are not limited to a particular type of computing device.

As shown in FIG. 1, computing device 100 includes a user interface 102 for information (e.g., data) entry, analysis, and/or visualization (e.g., display). User interface 102 can include, for example, a screen that can provide (e.g., display and/or present) information to a user (e.g., a human user) of computing device 100, as will be further described herein. For example, information can be provided to the user of computing device 100 in tabular information (e.g., a spreadsheet) displayed on the screen of user interface 102, as will be further described herein.

Additionally, computing device 100 can receive information from the user of computing device 100 through an interaction with the user via user interface 102, as will be further described herein. For example, the user of computing device 100 can enter information into the spreadsheet displayed on user interface 102, as will be further described herein. The user can enter the information into the spreadsheet using, for instance, a mouse and/or keyboard associated with computing device 100. In some embodiments, the mouse and/or keyboard can be a part of user interface 102.

As shown in FIG. 1, computing device 100 includes a processor 104 and a memory 106. Although not illustrated in FIG. 1, memory 106 can be coupled to processor 104.

Memory 106 can be volatile or nonvolatile memory. Memory 106 can also be removable, e.g., portable memory, or non-removable, e.g., internal memory. For example, memory 106 can be random access memory (RAM) and/or read-only memory (ROM) (e.g., dynamic random access memory (DRAM), electrically erasable programmable read-only memory (EEPROM), flash memory, phase change random access memory (PCRAM), compact-disk read-only memory (CD-ROM)), and/or a laser disk, a digital versatile disk (DVD) or other optical disk storage, and/or a magnetic medium such as magnetic cassettes, tapes, or disks, among other types of memory.

Further, although memory 106 is illustrated as being located in computing device 100, embodiments of the present disclosure are not so limited. For example, memory 106 can be located in a stand alone device and/or can be located internal to another computing resource, e.g., enabling computer readable instructions to be downloaded over the Internet or another type of wired or wireless connection.

Memory 106 can store executable instructions, such as, for example, computer readable instructions (e.g., software), for measuring information cohesion in an operating environment in accordance with one or more embodiments of the present disclosure. Processor 104 can execute the executable instructions stored in memory 106 to measure information cohesion in an operating environment in accordance with one or more embodiments of the present disclosure.

For example, in some embodiments, a number (e.g., a matrix) of information cohesion factors associated with an operating environment can be provided on user interface 102. For instance, the number of information cohesion factors can be displayed (e.g., to a user of computing device 100) in tabular information (e.g., a spreadsheet) displayed on user interface 102.

The operating environment can be, for example, a control room, such as, for instance, the control room of a commercial facility, manufacturing plant, or petrochemical processing facility. However, embodiments of the present disclosure are not limited to a particular type of operating environment.

Each information cohesion factor associated with the operating environment provided on user interface 102 can be a physical or cognitive distance (e.g., time and/or effort) associated with accessing (e.g., collecting, using, and/or assimilating) a particular (e.g., different) item of information (e.g., data) associated with the operating environment. The particular (e.g., each different) item of information associated with the operating environment can be, for example, an item of information needed by an operator in the operating environment to make the right decisions to effectively, efficiently, and/or safely operate the environment (e.g., the facility or plant). That is, information cohesion, as used herein, can refer to a measure of the physical and/or cognitive distance the operator in the operating environment may have to travel to access different (e.g., related) items of information in order to make the right decisions to effectively, efficiently, and/or safely operate (e.g., perform a task in) the environment.

A physical distance associated with accessing an item of information associated with the operating environment can include, for example, a spatial, a temporal, and/or a modality distance associated with accessing the item of information. A spatial distance associated with accessing an item of information can include, for example, a physical distance the operator in the operating environment may have to move (e.g., the distance the operator may have to move around his or her desk, whether the operator must get up out of his or her chair, the number of steps the operator may have to walk, and/or whether the operator has to walk to a different room) to access the item of information, a distance on a computer screen (e.g., how much of the screen) the operator may have to visually scan to access the item of information, the number of computer screens and/or windows on the screens the operator may have to view to access the item of information, and/or the number of mouse clicks needed by the operator to access the item of information. A temporal distance associated with accessing an item of information can include, for example, the timing of the operator's access to the item of information (e.g., when and/or how long the operator has access to the item of information) the refresh and/or coupling rate of the operator's access to the item of information (e.g., how often the operator has access to the item of information), the consistency of periodicity of the operator's access to the item of information (e.g., the consistency of the intervals between the operator's access to the item of information), and/or the amount of time it takes the operator to locate and/or travel to the item of information. A modality distance associated with access an item of information can include, for example, the load that accessing the item of information can create on the operator's visual, auditory, and/or tactile sensory systems (e.g., whether the operator may have to use multiple sensory systems to access the item of information, and/or problems the operating system may cause the operator in using his or her sensory systems to access the item of information).

A cognitive distance associated with accessing an item of information associated with the operating environment can include, for example, an identification of, an accessibility of, a completeness of, and/or a trust associated with the item of information. An identification of the item of information can include, for example, the semantics and/or system (e.g., coding, acronym(s), name(s), naming convention(s) computer language, and/or dialect(s)) used to identify the item of information, and/or whether different semantics and/or different systems are used to identify the item of information. An accessibility of the item of information can include, for example, the units in which the information is presented (e.g., whether the operator may have to convert the units in which the information is presented to different units) and/or whether the operator may have to derive additional and/or new information from the item of information. A completeness of the item of information can include, for example, whether the item of information may be present, but not useful, because the timestamp of the collection of the item of information (e.g., the freshness of the item of information) is not known. Trust associated with the item of information can include, for example, whether the operator trusts the information to be correct and/or accurate (e.g., whether the operator has been given incorrect and/or inaccurate information from a particular source on prior occasions).

While and/or after the number of information cohesion factors associated with the operating environment are provided on user interface 102, a number of information cohesion factor measurements (e.g., a measurement of each information cohesion factor) can be received via user interface 102. For example, the number of information cohesion factor measurements can be received via a number of entries made (e.g., by a user of computing device 100) in the tabular information displayed on user interface 102 (e.g., the spreadsheet on which the number of information cohesion factors are displayed). The measurement of a particular information cohesion factor (e.g., a particular information cohesion factor measurement) can be, for example, a measurement of a physical or cognitive distance associated with accessing a particular item of information associated with the operating environment.

The number of information cohesion factor measurements can be received from (e.g., made and/or entered into the tabular information displayed on user interface 102 by) a layperson. That is, the user of computing device 100 can be a layperson. For example, the number of information cohesion factor measurements can be received from a person who is familiar with (e.g., has knowledge and/or understanding of) the operating environment, but may not be familiar with the underlying psychological components of human cognition and/or competent engineering methods.

For example, the number of information cohesion factor measurements can be made and/or entered into the tabular information by a layperson who is observing the operator in the operating environment. For instance, the layperson observer can measure the number of information cohesion factors by observing the task context of the operator (e.g., what cognitive task the operator is trying to carry out), the starting point (e.g., the initial application source, computer screen, etc.) for the operator in accomplishing the task, the information the operator may need next (e.g., particular values, a particular application source and/or computer screen, etc.) to accomplish the task, the reason(s) the operator may need the information, what the operator may be comparing the information to, the difficulty the operator may have in obtaining and using the information, and/or identifying a problem(s) in the manner in which the information is provided to the operator.

In some embodiments, observations of the operator (e.g., information cohesion factor measurements) can be wholly or partially recorded by the use of automation to track the actions of the operator in the operating environment. Such recording mechanisms can include, for example, video records of the operator in the operating environment, video records of the operator's usage patterns with particular physical and/or software tools, eye-tracking measures that can indicate what is in the operator's field of vision and/or how the operator's attention is focused from one moment to the next, and/or keystroke tracking methods that can record what actions were taken within each software environment they access. Such recording methods can be reviewed and/or augmented by a human assessor who can fill in details that may not be directly interpreted by the automation. Such recording mechanisms can use an additional interface (e.g., a machine interface, not shown in FIG. 1) to collect the needed observations from an additional system (e.g., instead of from the human user).

While and/or after the number of information cohesion factor measurements associated with the operating environment are received via user interface 102, computing device 100 (e.g., processor 104) can determine a risk score associated with the operating environment by applying a weighting factor to the number of information cohesion factor measurements (e.g., to each information cohesion factor measurement). The risk score can represent a level of information cohesion associated with the operating environment (e.g., greater the risk score, lower the level of cohesion associated with the operating environment). For example, the risk score can represent an overall risk that the level of information cohesion associated with the operating environment may result in the operator not using one or more items of information in operating the environment and/or the operator expending extra (e.g., unnecessary) physical and/or cognitive distance (e.g., time and/or effort) to obtain one or more items of information. The risk score can be represented as, for example, a numerical value (e.g., the greater the risk score, the greater the numerical value).

For example, in some embodiments, computing device 100 can determine a risk score associated with each of the number of information cohesion factor measurements by applying a weighting factor to each of the number of information cohesion factor measurements. The risk score associated with a particular information cohesion factor measurement can represent a level of information cohesion associated with that particular information cohesion factor measurement. For example, the risk score associated with a particular information cohesion factor measurement can represent an overall risk that the level of information cohesion associated with a particular item of information may result in the operator not using the particular item of information in operating the environment and/or the operating expending extra physical and/or cognitive distance to obtain the particular item of information. The risk score associated with the operating environment can then be determined based, at least in part, on the risk scores associated with each information cohesion factor measurement. For example, the risk score associated with the operating environment can be determined by summing the risk scores associated with each information cohesion factor measurement.

The weighting factor that can be applied to a particular information cohesion factor (e.g., to a particular information cohesion factor measurement) can be selected from a number of pre-determined weighting factors stored in memory 106. The weighting factors can be represented as, for example, numerical values (e.g., from 0.0 to 3.0). The weighting factors can be pre-determined based, at least in part, on previous human factors experience and practice. In some embodiments, the weighting factors can be adjusted (e.g., by a human factors expert) based on, for example, the characteristics of the operating environment, the task the operator is attempting to accomplish, and/or the frequency with which the operator attempts to accomplish the task.

The weighting factor that can be applied to a particular information cohesion factor measurement can be based, at least in part, on a cognitive effect associated with the particular information cohesion factor measurement. For example, the greater the cognitive effect associated with the particular information cohesion factor measurement, the greater the weighting factor applied to the particular information cohesion factor measurement. That is, the weighting factor can represent the cost of the particular information cohesion factor measurement on the cognitive capacity (e.g., attention) of the operator in the operating environment (e.g., how difficult the information cohesion factor measurement may make the task the operator is attempting to accomplish), with the weighting factor (e.g., the numerical value representing the weighting factor) increasing as the cost on the cognitive capacity of the operator increases.

A cognitive effect associated with a particular information cohesion factor measurement can include, for example, the effect (e.g., demand) the particular information cohesion factor measurement (e.g., the effect accessing the item of information) may have on a cognitive capacity of the operator in the operating environment. For instance, the cognitive effect associated with a particular information cohesion factor measurement can include the perceptual, attentional, and/or memory effect (e.g., demand) the particular information cohesion factor measurement may have on the cognitive capacity of the operator in the operating environment.

The perceptual effect of a particular information cohesion factor measurement can include, for example, the fovea] Load of the information cohesion factor measurement on the operator (e.g., whether and/or how much information is presented in the front and/or central portion of the operator's field of view), the peripheral load of the information cohesion factor measurement on the operator (e.g., whether and/or how much information is presented in the peripheral portion of the operator's field of view), and/or the scanning load of the information cohesion factor measurement on the operator (e.g., whether and/or how much visual scanning the operator has to do to acquire information). The attentional effect of a particular information cohesion factor measurement can include, for example, the focused attention load of the information cohesion factor measurement on the operator (e.g., whether and/or how much information is acquired by the operator from a single source) and/or the divided attention load of the information cohesion factor measurement on the operator (e.g., whether and/or how much information is acquired by the operator simultaneously from multiple sources). The memory effect of a particular information cohesion factor measurement can include, for example, the long term memory load of the information cohesion factor measurement on the operator (e.g., whether and/or how much prior knowledge and/or expertise the operator may use to acquire information) and/or the working memory load of the information cohesion factor on the operator (e.g., whether and/or how much comprehension and/or analysis the operator may have to perform concurrently to acquire information).

The weighting factor that can be applied to a particular information cohesion factor measurement can also be based, at least in part, on a number of subjective and/or quantifiable measures of risk of occurrence associated with the item of information associated with the particular information cohesion factor measurement. For example, the greater the measure(s) of risk of occurrence, the greater the weighting factor. That is, the weighting factor can increase as the measure(s) of risk of occurrence increase.

The subjective and/or quantifiable measures of risk of occurrence associated with an item of information associated with a particular information cohesion factor measurement can include, for example, a risk severity measure, a frequency of occurrence measure, and/or a usage probability measure (e.g., a measurement of risk severity, frequency of occurrence, and/or usage probability) associated with the item of information. The risk severity measure can include, for example, a measure of how important the item of information is to the success of the operator's task and/or to the operator arriving at a correct conclusion about the operating environment (e.g., whether the operator can successfully accomplish the task and/or arrive at a correct conclusion about the operative environment with or without the item of information). The frequency of occurrence measure can include, for example, a measure of how often the operator encounters (e.g., needs and/or accesses) the item of information and/or how often the operator needs to complete the task. The usage probability measure can include, for example, a measure of the probability that the operator will accidentally or deliberately fail to use the item of information in the task.

The subjective and/or quantifiable measures of risk of occurrence can be represented as, for example, numerical values representing a scale of risk, which can be further defined with a specific narrative definition for human understanding. The numerical value that represents a particular measure of risk of occurrence can correspond to the level of that measure of risk of occurrence. For example, a low risk severity measure, a low frequency of occurrence measure, and/or a low usage probability measure can be represented as a 1, a moderate risk severity measure, a moderate frequency of occurrence measure, and/or a moderate usage probability measure can be represented as a 3, and a high risk severity measure, a high frequency of occurrence measure, and/or a high usage probability measure can be represented as a 9. However, embodiments of the present disclosure are not limited to a particular correspondence between the numerical values and the levels of measures of risk of occurrence.

For the layperson, the scale can include descriptions of how to assess whether the risk is low, moderate, or high. For example, a risk measure of low frequency of occurrence may be described as an activity that occurs only once per day, whereas a risk measure of high frequency of occurrence may be described as a task that occurs at least three times per hour. This quantitative description of the scale can be adjustable for different environments and/or tasks to correctly assess the impact within a particular operating environment.

After the risk score associated with the operating environment (e.g., the risk scores associated with the number of information cohesion factor measurements) is determined, the risk score(s) can be provided on user interface 102. For example, the risk score associated with the operating environment and/or the risk scores associated with the number of information cohesion factor measurements can be displayed (e.g., to the user of computing device 100) in the tabular information (e.g., spreadsheet) displayed on user interface 102.

As previously described herein, the risk score associated with the operating environment can represent a level of information cohesion associated with the operating environment, and the risk score associated with a particular information cohesion factor measurement can represent a level of information cohesion associated with that information cohesion factor measurement. In some embodiments, a risk score associated with the operating environment and/or a risk score associated with a particular information cohesion factor measurement that is above a pre-defined threshold may indicate a lack of information cohesiveness associated with the operating environment and/or the particular information cohesion factor, respectively. Accordingly, if the risk score associated with the operating environment and/or the risk score associated with a particular information cohesion factor measurement are above a pre-defined threshold, an indication of a lack of information cohesiveness associated with the operating environment and/or the particular information cohesion factor measurement, respectively, can be provided on user interface 102 (e.g., displayed in the tabular information displayed on user interface 102).

In some embodiments, a number of recommendations for improving the risk score associated with the operating environment and/or the risk scores associated with the number of information cohesion factor measurements can also be provided on user interface 102 (e.g., displayed in the tabular information displayed on user interface 102). The recommendations can include suggested changes to the operating system (e.g., to physical and/or software systems of the operating system) that could improve the risk scores and/or be associated with (e.g., tied to) specific features of the operating environment and/or specific items of information. For example, the recommendations can address and/or recommend ways of improving the presentation and/or accessibility of items of information that are being ineffectively presented to the operator, the presentation and/or accessibility of the items of information that result in the highest risk scores, the presentation and/or accessibility of the items of information accessed most often and/or compared to other items of information by the operator, the features of (e.g., problems with) the operating system that may result in the highest risk scores (e.g., that may have the most negative impact on the operator's performance), the presentation and/or accessibility of items of information that are needed by the operator but not accessed by the operator due to their inaccessibility, features (e.g., areas) of the operating system in which a lack of information cohesion is present and/or prevalent, the presentation and/or accessibility of the items of information that are most frequently accessed by the operator together in the same task, and/or the likelihood that different operators will independently reach the same conclusions using the same items of information in the same operating environment.

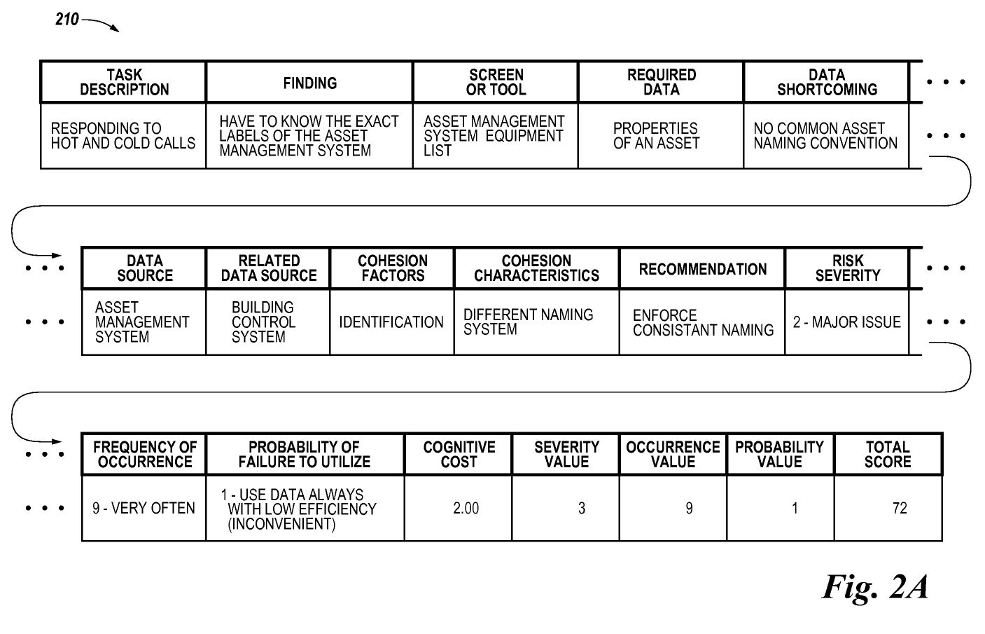

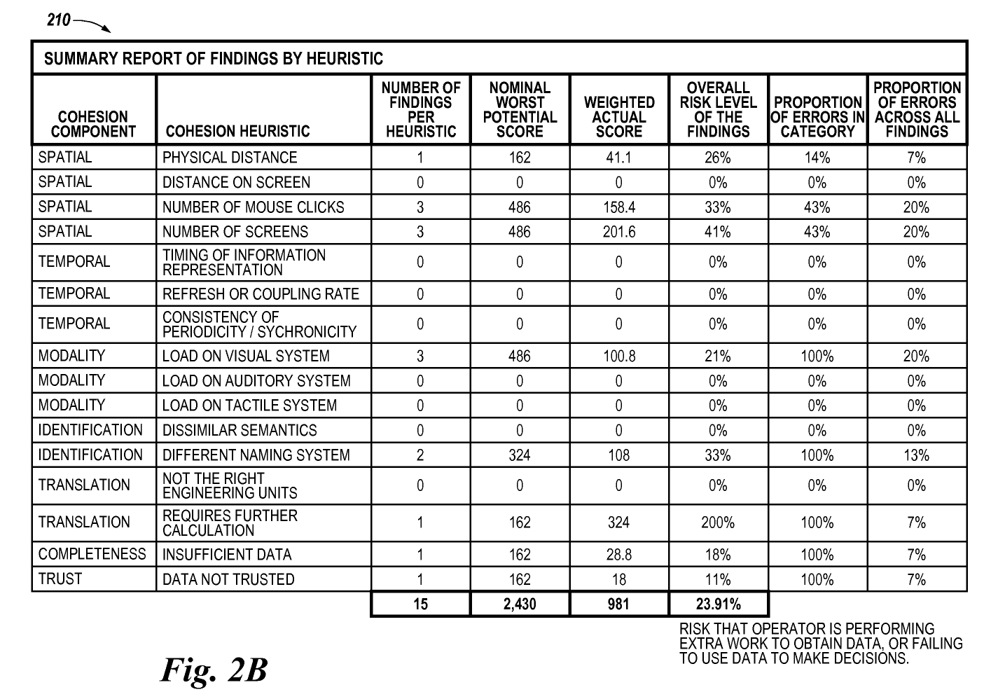

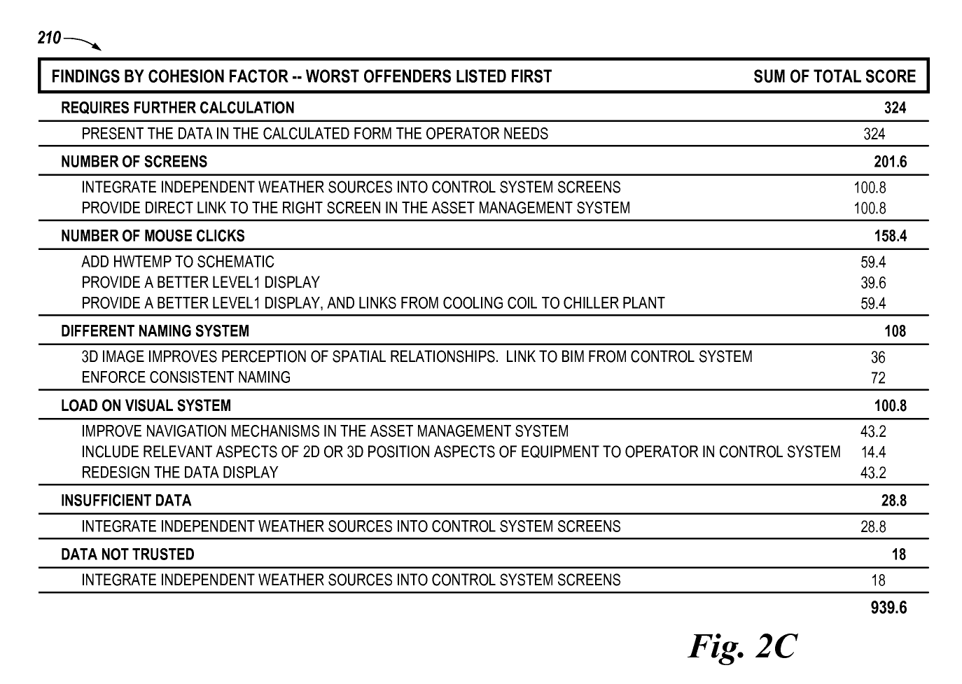

FIGS. 2A-2C illustrate portions of tabular information 210 defined in accordance with one or more embodiments of the present disclosure. Tabular information 210 can be, for example, a spreadsheet. However, embodiments of the present disclosure are not so limited.

Tabular information 210 can be an example of the tabular information (e.g., spreadsheet) previously described herein (e.g., in connection with FIG. 1). For instance, tabular information 210 can be displayed on user interface 102 of computing device 100 previously described herein in connection with FIG. 1.

The examples illustrated in FIGS. 2A-2C (e.g., tabular information 210) illustrate information (e.g., data) specific to a particular task to be performed by an operator in a particular operating environment. However, embodiments of the present disclosure are not limited to the information illustrated in FIGS. 2A-2C. Rather, embodiments of the present disclosure can include information associated with any type of task to be performed by an operator in any type of operating environment.

Additionally, the examples illustrated in FIGS. 2A-2C do not include the specific products (e.g., the names of specific products) being used by the operator. However, in some embodiments, the information displayed can include the specific products being used by the operator. Including the specific products being used by the operator can, for example, increase the clarity and/or specificity of the observations made of the operator and/or the recommendations for improving the operating environment.

The portion of tabular information 210 illustrated in FIG. 2A is a row of tabular information 210. As shown in FIG. 2A, the row provides data cells to receive (e.g., collect) information needed to support the identification of information cohesion issues in an operating environment, including, for example, a description of a task to be performed by an operator in an operating environment (e.g., responding to hot and cold calls in an asset management system) and a finding associated with the task (e.g., the operator has to know the exact labels within an external application or software such as the asset management system).

The row illustrated in FIG. 2A also includes a description of the screen or tool that can be used by the operator to access an item(s) of information (e.g., data) associated with the task, the data associated with the task (e.g., the data required for the task), any problems (e.g., shortcomings) with the data, and the sources of the data. The screen or tool is an asset management system equipment list, the required data is the properties of an asset, the data shortcoming is no common asset naming convention, and the data sources are the asset management system and building control system, as shown in FIG. 2A.

The row illustrated in FIG. 2A also includes an information cohesion factor and an information cohesion factor measurement (e.g., characteristic). The information cohesion factor is a cognitive distance associated with accessing the data (e.g., an identification of the data), and the information cohesion factor measurement (e.g., characteristic) is a measurement of the identification of the data (e.g., a different naming system for the data), as shown in FIG. 2A. The row also includes a recommendation for approving the risk score associated with the information cohesion factor (e.g., enforce consistent naming in the data).

The row illustrated in FIG. 2A also includes subjective and/or quantifiable measures of risk of occurrence associated with the data. The measures of risk of occurrence are a risk severity measure (e.g., value), a frequency of occurrence measure (e.g., value), and a usage probability measure (e.g., probability of failure to utilize) associated with the data, as shown in FIG. 2A. The risk severity value associated with the data is 3 (e.g., major issue), the frequency of occurrence measure associated with the data is 9 (e.g., very often), and the usage probability measure associated with the data is 1 (e.g., the data is used always with low efficiency), as shown in FIG. 2A.

The row illustrated in FIG. 2A also includes a weighting factor (e.g., cognitive cost) applied to the information cohesion factor measurement (e.g., to the different naming system for the data). The cognitive cost is 2.00, as shown in FIG. 2A. The row illustrated in FIG. 2A also includes a risk factor (e.g., total score) associated with the information cohesion factor measurement (e.g., 72).

The portion of tabular information 210 illustrated in FIG. 2B is a summary report arranged by information cohesion factor (e.g., heuristic). The information cohesion factors illustrated in FIG. 2B include a number of physical distances (e.g., spatial, temporal, and modality distances) and cognitive distances (e.g., identification, accessibility, completeness, and trust) associated with accessing an item of information previously described herein (e.g., in connection with FIG. 1). For example, the summary report includes the physical distance the operator may have to move to access the item of information, the distance on a computer screen the operator may have to visually scan to access the item of information, the number of mouse clicks needed by the operator to access the item of information, etc., as shown in FIG. 2B.

The summary report illustrated in FIG. 2B includes the number of times each information cohesion factor was measured (e.g., the number of findings per heuristic). For example, the physical distance the operator had to move to access the item of operation, the operator having to perform an additional (e.g., further) calculation, the data being incomplete (e.g., insufficient), and the data not being trusted by the operator to be complete and/or accurate were each measured once, a different naming system being used to identify the item of information was measured twice, etc., as shown in FIG. 2B. The summary report also includes the total (e.g., sum) of the number of times the information cohesion factors were measured (e.g., 15), as shown in FIG. 2B.

The summary report illustrated in FIG. 2B also includes the nominal worst potential score for each information cohesion factor (e.g., for the measurements of each information cohesion factor). For example, the nominal worst potential score for the physical distance the operator had to move to access the item of operation, the operator having to perform the additional (e.g., further) calculation, the data being incomplete (e.g., insufficient), and the data not being trusted by the operator to be complete and/or accurate was 162, the nominal worst potential score for the different naming system being used to identify the item of information was 324, etc., as shown in FIG. 2B. The summary report also includes the total (e.g., sum) of the nominal worst potential score for the information cohesion factors (e.g., 2,430), as shown in FIG. 2B.

The summary report illustrated in FIG. 2B also includes the risk score associated with each information cohesion factor (e.g., with the measurements of each information cohesion factor). The risk score associated with each information cohesion factor is expressed as both a weighted actual score and an overall risk level percentage associated with the each information cohesion factor, as shown in FIG. 2B. For example, the weighted actual score and the overall risk level associated with the physical distance the operator had to move to access the item of information were 41.1 and 26%, respectively, the weighted actual score and the overall risk level associated with the number of mouse clicks needed by the operator to access the item of information were 158.4 and 33%, respectively, the weighted actual score and the overall risk level associated with the number of computer screens the operator had to view to access the item of information were 201.6 and 41%, respectively, etc., as shown in FIG. 2B.

The summary report illustrated in FIG. 2B also includes the total (e.g., sum) of the weighted actual scores associated with the information cohesion factors (e.g., 981) and the average overall risk level percentage associated with the information cohesion factors (e.g., 23.91%). These numbers can express the total and/or overall risk score associated with the operating environment, which can represent the risk that the operator is expending (e.g., performing) extra time and/or effort (e.g., extra work) to obtain items of information (e.g., data) and/or failing to use data to make decisions while in operating in the environment.

The summary report illustrated in FIG. 2B also includes a proportion of errors in each category and across all findings associated with each information cohesion factor. For example, the proportion of errors in each category and across all findings associated with the physical distance the operator had to move to access the item of information were 14% and 20%, respectively, the proportion of errors in each category and across all findings associated with the number of mouse clicks needed by the operator to access the item of information were 43% and 20%, respectively, the proportion of errors in each category and across all findings associated with the number of computer screens the operator had to view to access the item of information were 43% and 20%, respectively, etc., as shown in FIG. 2B.

The portion of tabular information 210 illustrated in FIG. 2C is a summary report arranged by the risk score (e.g., weighted actual score) associated with each information cohesion factor (e.g., with the measurements of each information cohesion factor), with the information cohesion factors having the highest risk score associated therewith (e.g., the information cohesion factors that are the worst offenders) listed first. The information cohesion factors illustrated in FIG. 2C include the operator having to perform an additional (e.g., further) calculation, the number of computer screens the operator had to view to access the item of information, the number of mouse clicks needed by the operator to access the item of information, etc., as shown in FIG. 2C.

The summary report illustrated in FIG. 2C also includes the risk score (e.g., the sum of the total score) associated with each information cohesion factor (e.g., with the measurements of each information cohesion factor). For example, the risk score associated with the operator having to perform an additional (e.g., further) calculation is 324, the risk score associated with the number of computer screens the operator had to view to access the item of information is 201.6, the risk score associated with the number of mouse clicks needed by the operator to access the item of information is 158.4, etc., as shown in FIG. 2C.

The summary report illustrated in FIG. 2C also includes recommendations for improving the risk scores associated with the information cohesion factors. For example, the recommendation for improving the risk score associated with the operator having to perform an additional calculation is to present the data in the calculated form the operator needs, the recommendations for improving the risk score associated with the number of computer screens the operator had to view to access the item of information are to integrate independent weather sources into control system screens and to provide a direct link to the right screen in the asset management system, etc., as shown in FIG. 2C.

The summary report illustrated in FIG. 2C also includes the amount by which following and/or implementing the recommendations would reduce and/or eliminate the risk scores associated with the information cohesion factors. For example, presenting the data in the calculated form the operator needs would reduce the risk score associated with the operator having to perform an additional calculation by 324 (e.g., would eliminate this risk score), integrating independent weather sources into control system screens and providing a direct link to the right screen in the asset management system would each reduce the risk score associated with the number of computer screens the operator had to view to access the item of information by 100.8 (e.g., implementing both would eliminate this risk score), etc., as shown in FIG. 2C.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computing device for measuring information cohesion in an operating environment, comprising:
a memory; and
a processor coupled to the memory, wherein the processor is configured to execute executable instructions stored in the memory to:
receive a measurement of an information cohesion factor associated with an operating environment through an interaction with a human user via a user interface for information entry, analysis, and visualization; and
determine a risk score associated with the operating environment by applying a weighting factor to the measurement of the information cohesion factor, wherein the weighting factor is based, at least in part, on a cognitive effect associated with the information cohesion factor.

2. The device of claim 1, wherein the weighting factor is based, at least in part, on a number of subjective and quantifiable measures of risk of occurrence associated with an item of information associated with the information cohesion factor.

3. The device of claim 1, wherein the information cohesion factor is a physical or cognitive distance associated with accessing an item of information.

4. The device of claim 1, wherein the cognitive effect associated with the information cohesion factor is an effect of the information cohesion factor on a cognitive capacity of an operator in the operating environment.

5. The device of claim 1, wherein the risk score associated with the operating environment represents a level of information cohesion associated with the operating environment.

6. The device of claim 1, wherein the processor is configured to execute executable instructions stored in the memory to provide a recommendation for improving the risk score on the user interface.

7. A computer implemented method for measuring information cohesion in an operating environment, comprising:
receiving a number of information cohesion factor measurements associated with an operating environment through an interaction with a human user via a user interface for information entry, analysis, and visualization; and
determining a risk score associated with the operating environment by applying a weighting factor to each information cohesion factor measurement, wherein the weighting factor applied to a particular information cohesion factor measurement is based, at least in part, on:
a cognitive effect associated with the particular information cohesion factor measurement; and
a number of subjective and quantifiable measures of risk of occurrence associated with an item of information associated with the particular information cohesion factor measurement.

8. The method of claim 7, wherein:
at least one information cohesion factor measurement is a measurement of a physical distance associated with accessing an item of information; and
at least one information cohesion factor measurement is a measurement of a cognitive distance associated with accessing an item of information.

9. The method of claim 8, wherein the measurement of the physical distance associated with accessing the item of information includes at least one of:
a measurement of a spatial distance associated with accessing the item of information;
a measurement of a temporal distance associated with accessing the item of information; and
a measurement of a modality distance associated with accessing the item of information

10. The method of claim 8, wherein the measurement of the cognitive distance associated with accessing the item of information includes at least one of:
a measurement of an identification of the item of information;
a measurement of an accessibility of the item of information;
a measurement of a completeness of the item of information; and
a measurement of trust associated with the item of information.

11. The method of claim 7, wherein the cognitive effect associated with the particular information cohesion factor measurement includes:
a perceptual effect associated with the particular information cohesion factor measurement;
an attentional effect associated with the particular information cohesion factor measurement; and
a memory effect associated with the particular information cohesion factor measurement.

12. The method of claim 7, wherein the number of subjective and quantifiable measures of risk of occurrence associated with the item of information include:
a risk severity measure associated with the item of information;
a frequency of occurrence measure associated with the item of information; and
a usage probability measure associated with the item of information.

13. The method of claim 7, wherein the method includes providing an indication on the user interface of a lack of information cohesiveness associated with the operating environment if the risk score is above a pre-defined threshold.

14. The method of claim 7, wherein the method includes adjusting the weighting factor applied to each information cohesion factor measurement.

15. A computing device for measuring information cohesion in an operating environment, comprising:
a memory; and
a processor coupled to the memory, wherein the processor is configured to execute executable instructions stored in the memory to:
provide a number of information cohesion factors associated with an operating environment to a human user on a user interface of the computing device;
receive a measurement of each information cohesion factor through an interaction with the human user via the user interface;
determine a risk score associated with the operating environment by applying a weighting factor to the measurements of each information cohesion factor, wherein the weighting factor applied to the measurement of a particular information cohesion factor is based, at least in part, on a cognitive effect associated with the measurement of the particular information cohesion factor; and
provide the risk score to the human user on the user interface.

16. The computing device of claim 15, wherein the processor is configured to execute executable instructions stored in the memory to receive a number of information cohesion factor measurements from an automated measurement system, wherein the automated measurement system includes at least one of:
a keystroke tracker; and
an eye tracker.

17. The computing device of claim 15, wherein the processor is configured to execute executable instructions stored in the memory to:
display the number of information cohesion factors associated with the operating environment to the human user in tabular information on the user interface of the computing device;
receive the measurement of each information cohesion factor via a number of entries made by the human user in the tabular information; and
display the risk score to the human user in the tabular information.

18. The computing device of claim 15, wherein the processor is configured to execute executable instructions stored in the memory to:
determine a risk score associated with the measurements of each information cohesion factor by applying a weighting factor to the measurements of each information cohesion factor, wherein the weighting factor applied to the measurement of a particular information cohesion factor is based, at least in part, on a cognitive effect associated with the measurement of the particular information cohesion factor; and
determine the risk score associated with the operating environment by summing the risk scores associated with the measurements of each information cohesion factor.

19. The computing device of claim 18, wherein the risk score associated with the measurement of a particular information cohesion factor represents a level of information cohesion associated with the measurement of the particular information cohesion factor.

20. The computing device of claim 18, wherein the processor is configured to execute executable instructions stored in the memory to provide to the human user on the user interface a recommendation for improving the risk scores associated with the measurements of each information cohesion factor.
